(19) United States
(12) Patent Application Publication
(10) Pub. No.: US 2005/0007914 A1
(43) Pub. Date: Jan. 13, 2005

(54) Apparatus and method of recording a record map and write-once disc therefor

(75) Inventors: Sung-hee Hwang, Gangnam-gu (KR); Jung-wan Ko, Suwon-si (KR); Kyung-geun Lee, Seongnam-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/853,716

(22) Filed: May 26, 2004

Related U.S. Application Data
(60) Provisional application No. 60/479,492, filed on Jun. 19, 2003.

(30) Foreign Application Priority Data
May 28, 2003 (KR) 2003-34029
Jul. 9, 2003 (KR) 2003-46546
Apr. 23, 2004 (KR) 2004-28168

(51) Int. Cl. G11B 5/09

(52) U.S. Cl. 369/47.22; 369/59.23; 369/47.14; 369/53.15

(57) ABSTRACT

A method and apparatus for recording a record map, and a write-once disc therefore. The write-once disc has at least one recording layer and stores a record map which identifies locations of consecutive data blocks that are occupied with data or not occupied with data. Accordingly, the amount of data to be recorded on the write-once disc to indicate the data-recording status of the write-once disc is reduced so that the recording area of the write-once disc can be more efficiently used.

### CROSS-REFERENCE TO RELATED APPLICATIONS

This application claims the benefits of Korean Patent Application Nos. 2003-34029, filed on May 28, 2003, 2003-46546, filed on Jul. 9, 2003, and 2004-28168, filed on Apr. 23, 2004, in the Korean Intellectual Property Office, and the benefits of U.S. Provisional Patent Application No. 60/479,492, filed on Jun. 19, 2003, in the U.S. Patent and Trademark Office, the disclosures of which are incorporated herein in their entirety by reference.

### BACKGROUND OF THE INVENTION

1. Field of the Invention

The present invention relates to a write-once disc and a method and apparatus to record a record map which indicates the data-recording status of a write-once disc.

2. Description of the Related Art

In the conventional art, a bit map is recorded on an information storage medium, such as an optical disc, to represent which recordable areas of a disc individually contain data. More specifically, the bit map is produced in such a way that different bit values are allocated for data blocks having data and data blocks not having data. A data block is a unit in which data is recorded on a disc. The data block is also the size of the error correction unit, and is commonly composed of either 32 or 64 kilobytes.

If a bit map of 64-kilobyte data blocks is recorded on an optical disc, a bit map representing 32 gigabytes of data can be recorded on a single data block. In next-generation optical discs, each recording layer has a recording capacity of about 25 gigabytes. Hence, a bit map for a disc having a single recording layer can be recorded in a single data block, but a bit map for a disc having a double recording layer requires at least two data blocks to be recorded therein.

In write-once discs where an area occupied with data cannot be overwritten with new data, an update of data recorded in an area must be recorded in a different unoccupied area.

Hence, when a bit map is updated by new data recorded on a write-once disc with a double recording layer, at least two additional data blocks must be allocated on the write-once discs to record an update of the bit map. Even in write-once discs with a single recording layer, if the recording capacity of the single recording layer is more than 32 gigabytes, at least two blocks must be allocated to record the updated bit map for every update.

As described above, when a conventional bit map is used to represent which recordable areas on a write-once disc contain data, the amount of data to be recorded on the write-once disc is increased, and thus, a large portion of the entire recording space of the disc is occupied with data related to the bit map. Also, in spite of occupying a large recording space, a conventional bit map of recording units cannot represent useful information other than information about whether each recordable disc area individually contains data.

### SUMMARY OF THE INVENTION

Additional aspects and/or advantages of the invention will be set forth in part in the description which follows and, in part, will be obvious from the description, or may be learned by practice of the invention.

The present invention provides a method and apparatus for recording a record map which more efficiently indicates the data-recording status of a write-once disc.

The present invention also provides a write-once disc on which a record map which more efficiently indicates the data-recording status of the write-once disc is recorded.

According to an aspect of the present invention, a method of recording a record map on a write-once disc comprises: recording new data in data block units on the write-once disc; producing a record map which identifies locations of consecutive data blocks that are occupied with data or not occupied with data; and recording the record map in a predetermined area allocated in the write-once disc.

According to another aspect of the present invention, a data recording and/or reproducing apparatus comprises a writer/reader and a controller. The writer/reader writes data on a write-once disc and/or reads the written data from the write-once disc. The controller controls the writer/reader to write new data in the write-once disc in data block units, produces a record map which identifies locations of occupied and/or unoccupied consecutive data blocks, and controls the writer/reader to record the record map in a predetermined area of the write-once disc.

According to still another aspect of the present invention, there is a write-once disc having at least one recording layer, the disc comprising a record map which identifies locations of consecutive data blocks that are occupied with data and/or not occupied with data.

### BRIEF DESCRIPTION OF THE DRAWINGS

The above and/or other features and advantages of the present invention will become more apparent by describing in detail exemplary embodiments thereof with reference to the attached drawings in which:

FIG. 1A shows a structure of a write-once disc having a single recording layer according to an aspect of the present invention;

FIG. 1B shows a structure of a write-once disc having a double recording layer according to an aspect of the present invention;

FIG. 2 shows a record map according to an aspect of the present invention;

FIG. 3 shows the record map entry of FIG. 2 according to an aspect of the present invention;

FIG. 4 shows the record map entry of FIG. 2 according to another aspect of the present invention;

FIG. 5 shows an example of the entry information of FIGS. 3 and 4;

FIG. 6 shows an example of a case where consecutive data blocks covered by a record map entry are determined to be unusable;

FIGS. 7A and 7B show other examples of consecutive data blocks covered by a record map entries being determined to be unusable;

FIG. 8 shows a disc area for recording a record map according to an aspect of the present invention;

FIG. 9 shows a detailed structure of a write-once disc having a single recording layer according to an aspect of the present invention;

FIG. 10 shows the temporary defect management area of FIG. 9 according to an aspect of the present invention;

FIG. 11 shows a block for a temporary disc defect structure of FIG. 10 according to an aspect of the present invention;

FIG. 12 is a block diagram of a data recording and/or reproducing apparatus according to an aspect of the present invention; and

FIG. 13 is a flowchart illustrating a method of recording a record map, according to an aspect of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

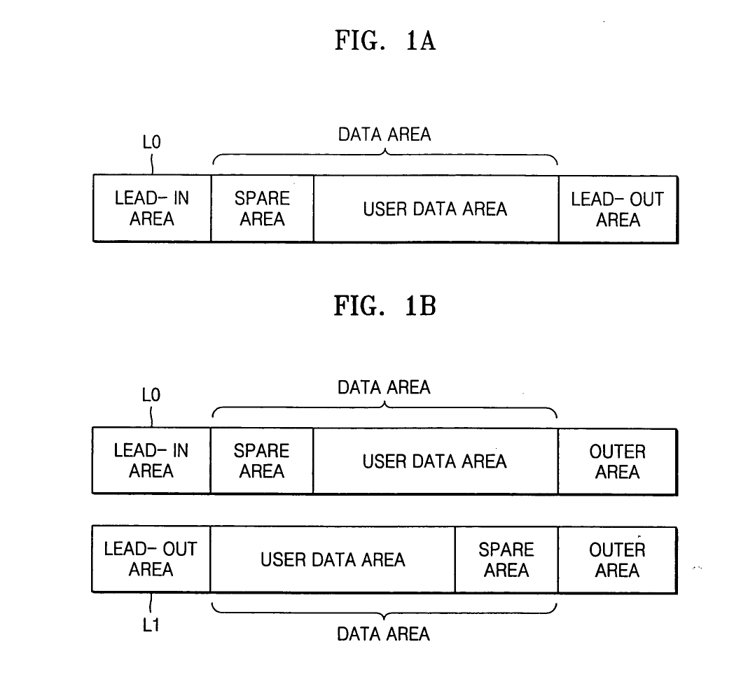

FIG. 1A shows a structure of a write-once disc having a single recording layer according to an aspect of the present invention. FIG. 1B shows a structure of a write-once disc having a double recording layer according to another aspect of the present invention.

Referring to FIG. 1A, if a disc has a single recording layer L0, it includes a lead-in area, a data area, and a lead-out area. The lead-in area is located near the inner boundary of the disc, and the lead-out area is located near the outer boundary of the disc. The data area is formed between the lead-in area and the lead-out area, and is divided into a spare area and a user data area.

The user data area is for recording user data, while the spare area is used to replace recordable space in the user data area which is lost due to a defect. Since it is important that the disc provides a maximum capacity for recording data while allowing for defects, the spare area is initially set to about 5% of the entire data capacity.

Referring to FIG. 1B, if a disc has two recording layers L0 and L1, the recording layer L0 has a lead-in area, a data area, and an outer area, which are sequentially formed from the inner boundary of the disc to the outer boundary of the disc. The recording layer L1 has an outer area, a data area, and a lead-out area, which are sequentially formed from the outer boundary of the disc to the inner boundary of the disc. In the double-recording layer disc of FIG. 1B, data is recorded in the recording layer L0 outward from the inner boundary of the disc, while data is recorded in the recording layer L1 inward from the outer boundary of the disc.

In the discs of FIGS. 1A and 1B, spare areas exist between either the lead-in area and the user data area of the outer area and the user data area. However, the spare area may be formed in various locations. Furthermore, a spare area may not be present according to a user's selection or a program pre-stored in a data recording and/or reproducing apparatus.

In an aspect of the present invention, a record map representing the locations of consecutive data blocks that are occupied and/or unoccupied with data is recorded on a write-once disc to more efficiently indicate the data-recording status of the write-once disc.

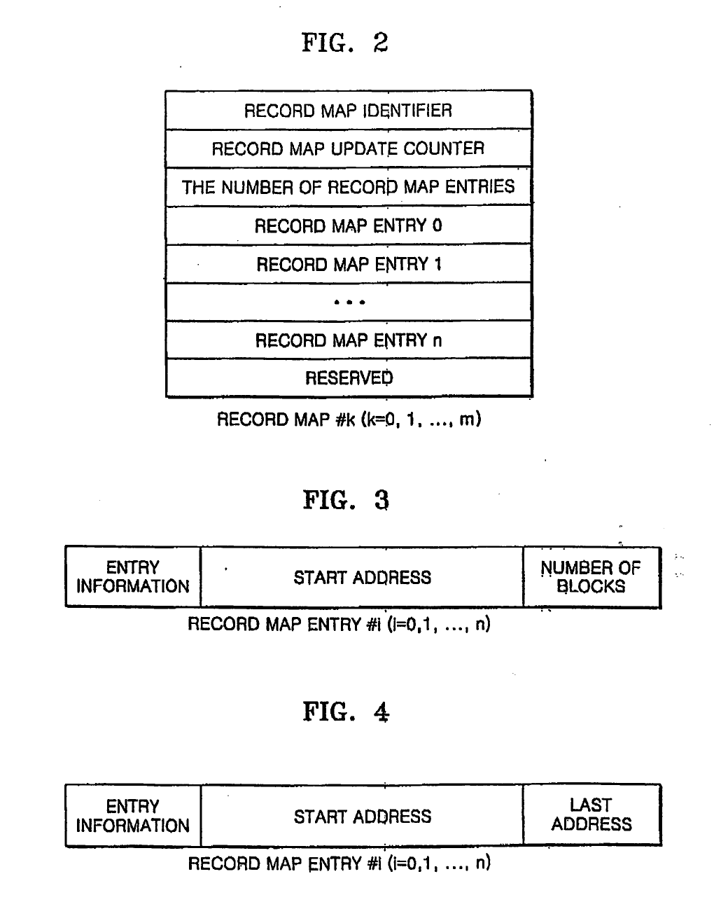

FIG. 2 shows a record map according to an aspect of the present invention. Referring to FIG. 2, a record map #k includes a record map identifier, a record map update counter, the number of record map entries, a plurality of record map entries, and a reserved area. The record map update counter indicates the number of an update to the record map. Each of the record map entries includes entry information, which contains information about the locations of occupied and/or unoccupied consecutive data blocks, and information about the occupied and/or unoccupied consecutive data blocks.

FIG. 3 shows a record map entry of FIG. 2 according to an aspect of the present invention. Referring to FIG. 3, a record map entry #i includes entry information, a start address, and the number of data blocks.

The entry information of the record map entry #i includes information about a recording layer with consecutive data blocks that are represented by the, record map entry # i, information regarding whether the blocks contain data, information regarding an area having the blocks, and information representing whether the blocks are defective.

According to an aspect of the present invention as shown in FIG. 3, the locations of the consecutive data blocks to be represented by a record map entry are indicated by identifying the address of a first block among the consecutive data blocks and the number of consecutive data blocks. Alternatively, the address of the last data block among the consecutive data blocks may be identified instead of the start address.

The size of a record map entry varies according to the overall capacity of a disc or other conditions of the disc. In discs with two recording layers each having a recording capacity of about 25 gigabytes, 8 bytes are enough to form a record map entry. Among the 8 bytes, one byte is used for entry information, four bytes are used for a start address, and the remaining three bytes are used for the number of blocks.

If a single record map entry is composed of 8 bytes, and a data block, which is a recording unit, is composed of 64 kilobytes, one data block can contain about 8000 record map entries. Hence, in the case of double-recording layer discs as well as single-recording layer discs, a record map recorded in a single block can indicate the data-recording status of all the recordable areas of a write-once disc in a single block.

FIG. 4 shows the record map entry of FIG. 2 according to another aspect of the present invention. Referring to FIG. 4, a record map entry #i includes entry information, a start address, and a last address.

The entry information and the start address of FIG. 4 are similar to those of FIG. 3. In the embodiment of FIG. 4, the start address, which denotes the address of a first data block, and the last address, which denotes the address of the last data block, are recorded to indicate the locations of the consecutive data blocks.

The start address and the last address recorded in a record map entry will now be described in greater detail. Generally, a data block is divided into a plurality of sectors, to each of which a physical sector address is allocated. The start address denotes the address of a first sector of a first data block among an area that is represented by a record map entry #i.

The last address varies depending on recording-status information included in the entry information of the record map entry #i. If the area represented by the record map entry #i is not occupied with data, the last address denotes the address of a first physical sector of the last data block. If the area represented by the record map entry #i is occupied with data, the last address denotes the address of the last physical sector in which effective data has been stored. If a data block is composed of 16 sectors, two of 16 sectors of the last data block store effective data, and the remaining 14 sectors are represented by a value such as “00h” added by a disk driver. The last address denotes a physical sector address representing a second sector of the last data block.

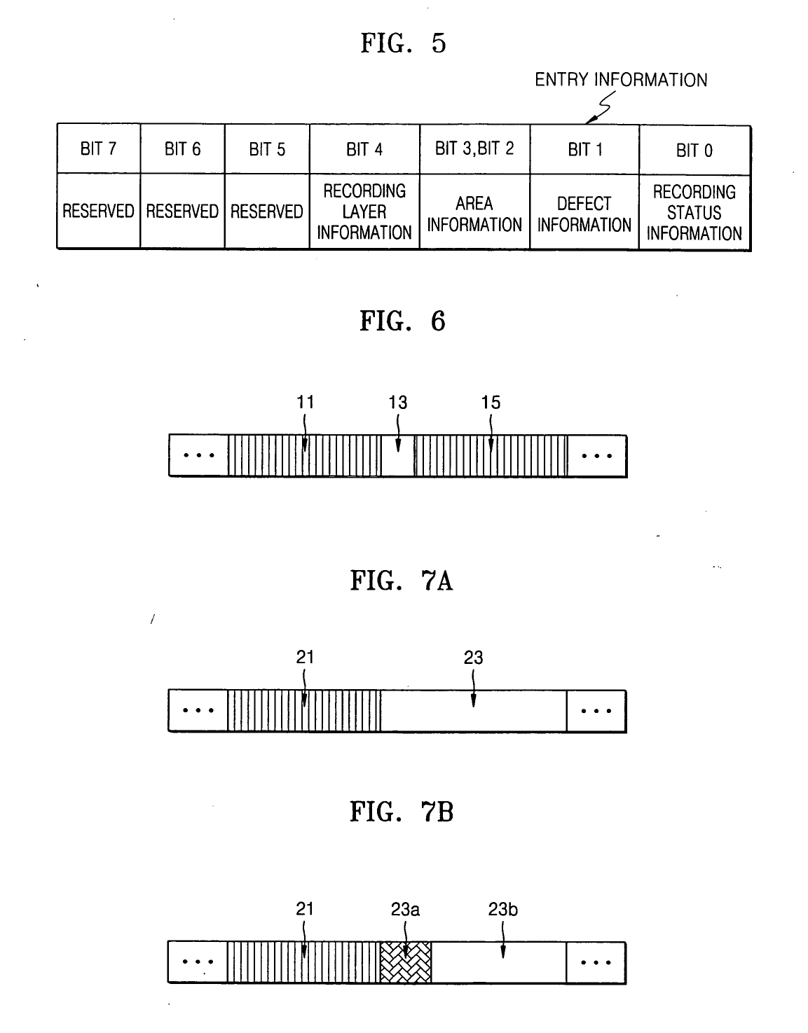

FIG. 5 shows an example of the entry information of FIGS. 3 and 4. Referring to FIG. 5, the entry information is composed of 8 bits which are referred to as the zeroth through seventh bits. The zeroth bit stores recording-status information, the first bit stores defect information, the second and third bits store area information, the fourth bit stores recording layer information, and the fifth through seventh bits are reserved areas.

If the bit value of the zeroth bit is 0, it represents that consecutive data blocks represented by a record map entry are not occupied with data. If the bit value of the zeroth bit is 1, it represents that the consecutive data blocks represented by the record map entry are occupied with data.

If the bit value of the first bit is 0, the consecutive data blocks covered by the record map entry are recordable. In other words, if the bit value of the zeroth bit is 0, consecutive data blocks covered by the record map entry are recordable. On the other hand, if the bit value of the zeroth bit is 1, the consecutive data blocks covered by the record map entry are reproducible. If the bit value of the first bit is 1, this represents that the consecutive data blocks covered by the record map entry are unusable. In other words, when the first bit is 1 and the bit value of the zeroth bit is 0, it represents that the consecutive data blocks covered by the record map entry are not recordable, and if the bit value of the zeroth bit is 1, it represents that the consecutive data blocks covered by the record map entry are not reproducible.

The second and third bits represent an area to which the consecutive data blocks covered by the record map entry belong. In the write-once disc with a single recording layer of FIG. 1A, if the bit values of the second and third bits are “00”, the consecutive data blocks covered by the record map entry belong to the lead-in area. If the bit values of the second and third bits are “01”, the consecutive data blocks covered by the record map entry belong to the data area. If the bit values of the second and third bits are “10”, the consecutive data blocks covered by the record map entry belong to the lead-out area. If the bit values of the second and third bits are “11”, the consecutive data blocks covered by the record map entry are reserved areas.

In the case of write-once discs with double recording layers, when the bit value of the fourth bit is 0, the consecutive data blocks covered by the record map entry are located in the recording layer L0. When the bit value of the fourth bit is 1, the consecutive data blocks covered by the record map entry are located in the recording layer L1.

In FIG. 5 where the first bit, representing defect information included in the entry information, is 1, that is, the case where the consecutive data blocks covered by the record map entry are determined to be unusable, will now be described in greater detail.

The case where the consecutive data blocks covered by the record map entry are determined to be unusable may more accurately be classified into two cases.

In the first case, the consecutive data blocks covered by the record map entry are not occupied with data and are determined to be unusable, so the first bit has a bit value of 1.

FIG. 6 shows an example of a case where consecutive data blocks covered by a record map entry are determined to be unusable. Referring to FIG. 6, th, N-th, and th data areas 11, 13, and 15 are shown. When the th and th data areas 11 and 15 are occupied with data, and the N-th data area 13 may not be written with data because it is too small or because the host does not want to record data in the N-th data area 13. In this case, a data recording and/or reproducing apparatus records the bit value of the first bit of the entry information of a record map entry #N corresponding to the N-th data area 13 as 1 in response to a command from the host to thereby represent that the N-th data area 13 is not recordable.

In the second case, an area covered by a record map entry I is occupied with data and determined to be unusable, so the first bit has a bit value of 1.

FIGS. 7A and 7B show examples of the case where consecutive data blocks covered by a record map entry are determined to be unusable. Referring to FIG. 7A, th and M-th data areas 21 and 23 are shown. Data is recorded in up to the th data area 21, while the M-th data area 23 does not contain data.

Hence, in a final record map, the zeroth bit of the entry information of a record map entry # corresponding to the th data area 21 has a bit value of 1 to represent that the th data area 21 is occupied with data. The zeroth bit of the entry information of a record map entry #M corresponding to the M-th data area 23 has a bit value of 0 to represent that the M-th data area 23 is not occupied with data. The first bit of the entry information of the record map entry #M has a bit value of 0 to represent that the M-th data area 23 is usable, that is, recordable.

In response to a data recording command from the host, the data recording and/or reproducing apparatus records data in the M-th data area 23, which is next to the th data area 21 occupied with data. FIG. 7B shows a data area when recording is stopped due to power-down of the data recording and/or reproducing apparatus in the middle of data recording in the M-th data area 23.

When an abnormal situation, such as power-down due to an electricity failure, occurs while the data recording and/or reproducing apparatus is recording data in an area 23a of the M-th data area 23, data recording is not properly performed, and the record map cannot be updated.

When such an abnormal situation occurs in the M-th data area 23, the data recording and/or reproducing apparatus searches the record map entry # of a final record map for the address of the last data block of data blocks in which data is properly recorded. The data recording and/or reproducing apparatus scans from the area behind the last data block, that is, the M-th data area 23 to recognize that data is written up to the area 23a, and produces a new record map entry #M that indicates the data-recording status of the area 23a. In the new record map entry #M, 1 is recorded as the bit values of the zeroth and first bits. In other words, the new record map entry #M includes information representing that the area 23a is occupied with data but is not useable. The area 23a can be rendered unusable by a variety of occurrences, a loss of power being mentioned only as an example thereof.

In a record map entry # corresponding to an area 23b, 0 is recorded as the bit values of the zeroth and first bits to represent that the area 23b is not occupied with data and is usable.

When a record map is not properly updated due to an occurrence of an abnormal circumstance, such as power-down, during data recording as described above, the host determines the M-th data area 23 to be recordable and later commands the data recording and/or reproducing apparatus to re-record data in the M-th data area 23. However, as described above, the data recording and/or reproducing apparatus can take a suitable measure by referring to the restored record map. For example, if the disc is a write-once disc, the data recording and/or reproducing apparatus informs the host that an area where the host commands data to be recorded is occupied with data and induces the host to command data recording in another area. Alternatively, the data recording and/or reproducing apparatus can record data in a spare area according to defect management.

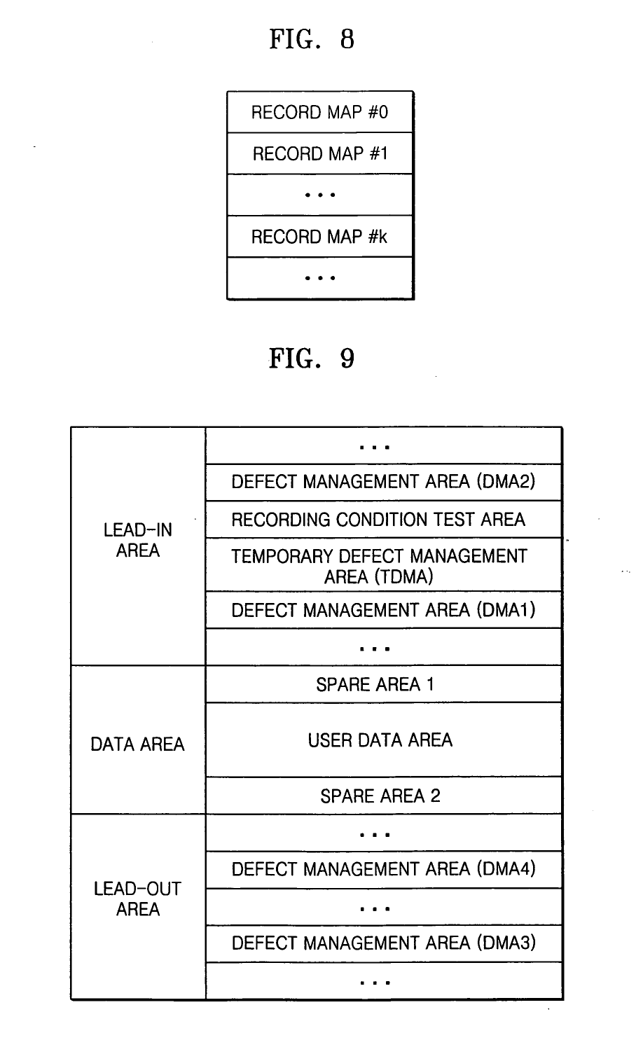

An area of a write-once disc for recording a record map according to an aspect of the present invention will now be described with reference to FIG. 8. Referring to FIG. 8, the record map area is composed of a plurality of data blocks, in each of which a single record map is recorded. The record map area is distinguished from other areas and allocated an area on the write-once disc.

In one aspect of the present invention, the record map area is allocated to a lead-in area or a lead-out area of the write-once disc because of the characteristics of the record map area. However, if a circumstance, such as a case where the number of updates to a record map must be limited due to a lack of recording space in the lead-in area or the lead-out area occurs, the record map area may be allocated to a data area of the write-once disc.

FIG. 9 shows a detailed structure of a write-once disc having a single recording layer according to an aspect of the present invention. Referring to FIG. 9, a lead-in area of the write-once disc includes defect management areas DMA1 and DMA2, a recording condition test area, and a temporary defect management area. A data area of the disc includes spare areas 1 and 2 and a user data area. In this aspect, to perform temporary defect management, the spare area 1 is allocated at the head of the data area, and the spare area 2 is allocated at the rear of the data area. To perform defect management, a lead-out area of the write-once disc includes defect management areas DMA3 and DMA4 separate from the defect management areas DMA1 and DMA2 included in the lead-in area.

Typically, defect management areas, which stores information about defects generated while recording data in a data area, are formed in a lead-in area and/or a lead-out area. Defect management includes compensating for a data loss due to a generated defect by re-recording the user data that was to be recorded in a defective user data area.

When a disc is loaded in a disc drive, the disk drive performs initialization. The initialization operation includes ascertaining how to manage the disc and how to record to or reproduce data from the disc by reading out data, including defect data, from a lead-in area and/or a lead-out area.

As the amount of data recorded in the lead-in area and/or the lead-out area increases, the time required for initialization after disk loading is increased. To reduce the time required for initialization, the concept of temporary management data is introduced, and a temporary disc defect structure and a temporary defect list are recorded in the TDMA, which is separate from the DMAs of the lead-in area and/or the lead-out area.

A TDFL is composed of data indicating defect areas and data indicating recently replaced areas. A TDDS is used to manage a TDFL and may include a TDDS identifier, an update count, information indicating a location where a final TDFL has been recorded, information indicating a location where final disc and drive information has been recorded, information indicating a size of a spare area to replace a defective cluster, and the like. In the FIG. 9, the TDDS further includes the record map of the present invention.

FIG. 10 shows the TDMA of FIG. 9 having TDFLs and TDDSs according to an aspect of the present invention. Referring to FIG. 10, each of the TDDSs and the TDFLs is recorded in one data block. The TDMA is not divided into a specific area for a TDDS and a specific area for a TDFL.

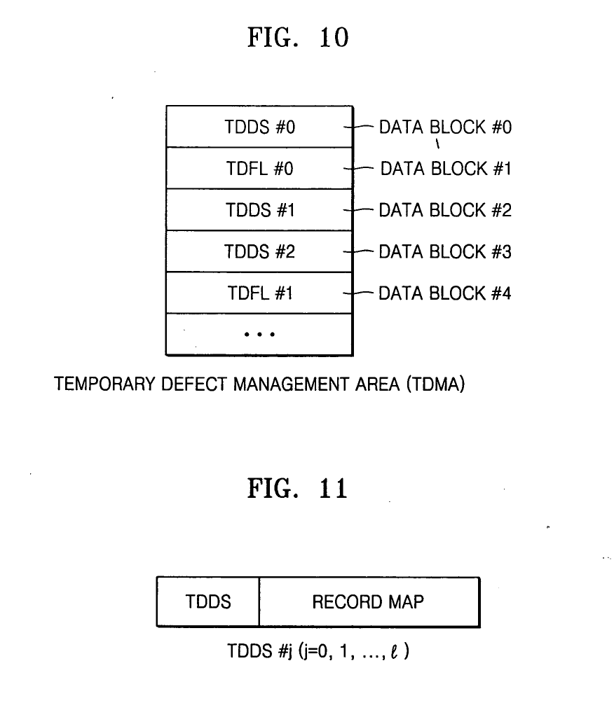

FIG. 11 shows a structure of a TDDS #j of FIG. 10 according to an aspect of the present invention. Referring to FIG. 11, the TDDS #j includes a TDDS and a record map. As described above, the TDDS includes a TDDS identifier, an update count, information indicating a location where a final TDFL has been recorded, information indicating a location where final disc and drive information has been recorded, information indicating a size of a spare area to replace a defective cluster, and/or the like.

FIG. 12 is a block diagram of a data recording and/or reproducing apparatus according to an aspect of the present invention. Referring to FIG. 12, the apparatus comprises a writer/reader 1, a controller 2, and a memory 3. A write-once disc 100 has the structure shown in FIG. 9.

The writer/reader 1 writes data to the write-once disc 100 under control of the controller 2 and reads out the written data from the write-once disc 100 to verify the same.

The controller 2 reads out a record map of the present invention, which is pre-recorded on the write-once disc 100, and controls the apparatus to record an updated record map on the write-once disc 100.

Upon recording and/or reproducing the data, the controller 2 performs defect management using a TDMA that is included in the write-once disc 100. In other words, the controller 2 follows a verify-after-writing course, in which after data is recorded in predetermined units on the write-once disc 100, the recorded data is verified to find defective data. Accordingly, the controller 2 records user data in predetermined units and verifies the recorded data to identify defective data. The controller 2 produces a TDFL, which indicates the area where defective data found during verification is stored, and a TDDS. The controller 2 stores the TDFL and the TDDS in the memory 3, collects a predetermined amount of TDFL and TDDS, and writes the collected TDFL and TDDS to the TDMA on the write-once disc 100.

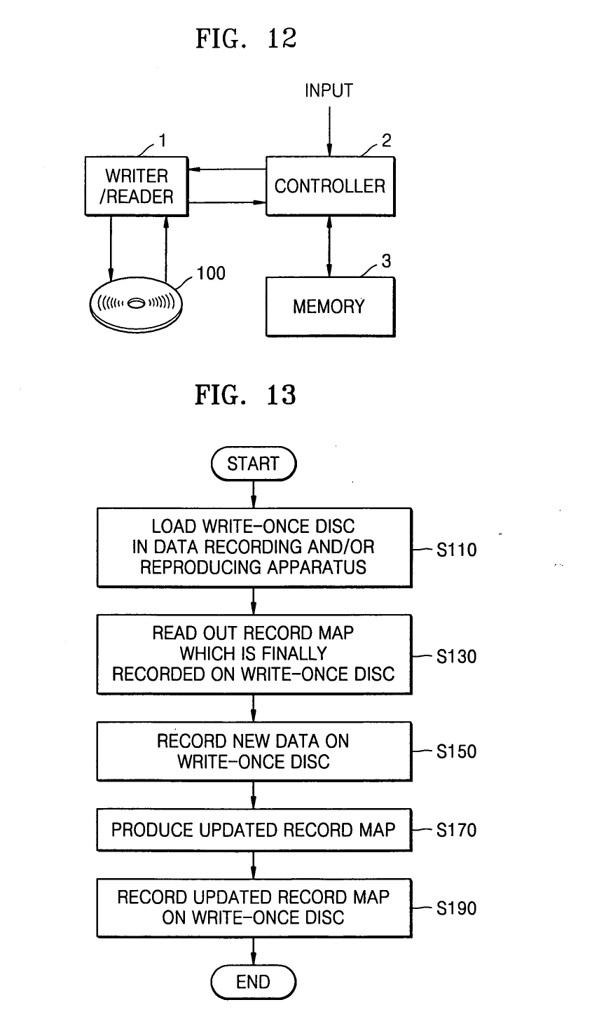

Record map recording according to an aspect of the present invention by the data recording and/or reproducing apparatus of FIG. 12 will now be described with reference to FIG. 13, which is a flowchart illustrating a record map recording method according to an aspect of the present invention.

First, when the write-once disc 100 is loaded in the data recording and/or reproducing apparatus of FIG. 12 in operation S110, initialization for the use of the write-once disc 100 is performed. The use of the write-once disc 100 denotes reading or reproduction of data recorded on the write-once disc 100 or recording of new data onto the write-once disc 100. The initialization denotes a process in which fundamental information for the use of the write-once disc 100 is read out of a lead-in area of the write-once disc 100 and stored in the memory 3 of the data recording and/or reproducing apparatus. Examples of the fundamental information include the type of the write-once disc 100, a version of a specification, a TDFL, a record map, and the like.

In operation S130, in response to the initialization for the use of the write-once disc 100, the controller 2 controls the writer/reader 1 to read out a record map which is recorded on the write-once disc 100. As shown in FIG. 11, the record map is recorded in a data block together with a TDDS. The controller 2 reads out a TDDS data block finally recorded in a TDMA, extracts a final record map from the TDDS data block, and stores the final record map in the memory 3.

In operation S150, the controller 2 controls the writer/reader 1 to record new data on the write-once disc 100 in data block units. The new data may be user data or other data, such as a TDFL used to manage the write-once disc 100.

In operation S170, the controller 2 produces an updated record map according to an aspect of the present invention as described above. The controller 2 produces the updated record map by updating the final record map stored in the memory 3.

The timing of an update to a record map may vary. For example, when a user issues an eject command to stop the use of the write-once disc 100, the record map may be updated. Alternatively, the data recording and/or reproducing apparatus may be programmed so that when the amount of new data recorded on the write-once disc 100 reaches a predetermined amount, the record map is updated. In addition, the timing of an update to a record map may be determined by a manufacturer of the data recording and/or reproducing apparatus or a user.

Although not shown in FIG. 13, when additional new data is recorded on the write-once disc 100, the controller 2 re-updates the updated record map stored in the memory 3 before the write-once disc 100 is ejected.

In operation S190, the controller 2 controls the writer/reader 1 to read out the updated record map stored in the memory 3 and record the same in a predetermined area of the write-once disc 100, for example, a TDMA.

As described above, in the apparatus and method of recording a record map according to the embodiment of the present invention, the amount of data to be recorded on a write-once disc to represent the data-recording status of the write-once disc is reduced so that the recording area of the write-once disc can be more efficiently used. The record map provides not only information about the data-recording statuses of data blocks but also other information about the data blocks.

Although a few embodiments of the present invention have been shown and described, it would be appreciated by those skilled in the art that changes may be made in this embodiment without departing from the principles and spirit of the invention, the scope of which is defined in the claims and their equivalents.

1. A write-once disc having at least one recording layer, the disc comprising a record map which identifies locations of consecutive data blocks that are occupied with data or not occupied with data.

2. The write-once disc of claim 1, wherein:
the record map comprises a plurality of record map entries; and
each of the record map entries comprises:
location information identifying the locations of the occupied or unoccupied consecutive data blocks; and
entry information indicating whether the data has been recorded in the consecutive data blocks.

3. The write-once disc of claim 2, wherein the location information comprises:
an address of a first data block of the consecutive data blocks; and
the number of consecutive data blocks.

4. The write-once disc of claim 2, wherein the location information comprises:
an address of a last data block of the consecutive data blocks; and
the number of consecutive data blocks.

5. The write-once disc of claim 2, wherein the location information comprises:
an address of a first data block of the consecutive data blocks; and
an address of a last data block of consecutive data blocks.

6. The write-once disc of claim 2, wherein the entry information comprises at least one of:
information indicating whether a defect exists in the consecutive data blocks;
information identifying a disc area to which the consecutive data blocks belong; and
information identifying a recording layer to which the consecutive data blocks belong if the write-once disc has at least two recording layers.

7. The write-once disc of claim 1, further comprising a temporary defect management area to store the record map.

8. The write-once disc of claim 7, wherein the temporary defect management area comprises:
a temporary disc defect list to identify defective locations of the write-once disc and/or recently replaced areas of the write-once disc; and
a temporary disc defect structure to manage the temporary disc defect list.

9. The write-once disc of claim 8, wherein the temporary disc defect structure comprises at least one of:
a temporary disc defect structure identifier to indicate that an area of the write-once disc is used as a temporary disc defect structure;
an update counter to indicate a number of times the temporary disc defect list has been updated;
information indicating where a final temporary disc defect list has been recorded; and
information indicating a size of a spare area used to replace a defective area of the write-once disc.

10. The write-once disc of claim 9, wherein the temporary disc defect structure comprises the record map.

11. The write-once disc of claim 1, wherein the record map further comprises:
a record map identifier to identify a disc area as containing a record map; and
a record map update counter to indicate a number of times that the record map has been updated with new data.

12. The write-once disc of claim 2, wherein each of the record map entries is composed of 8 bytes.

13. The write-once disc of claim 12, wherein of the 8 bytes, one byte is used for entry information, four bytes are used for a start address, and three bytes are used to indicate a number of consecutive data blocks.

14. The write-once disc of claim 6, wherein the defects may be caused by a loss of power while data is being written to the write-once disc.

15. A method of recording a record map on a write-once disc, the method comprising:
recording new data in data block units on the write-once disc;
producing a record map which identifies locations of consecutive data blocks that are either occupied with data or not occupied with data; and
recording the record map in a predetermined area of the write-once disc.

16. The method of claim 15, wherein:
the record map comprises a plurality of record map entries; and
each of the record map entries comprises:
location information identifying the locations of the occupied or unoccupied consecutive data blocks; and
entry information indicating whether the data has been recorded in the consecutive data blocks.

17. The method of claim 16, wherein the location information comprises:
an address of a first data block of the consecutive data blocks; and
the number of consecutive data blocks.

18. The method of claim 16, wherein the location information comprises:
an address of a last data block of the consecutive data blocks; and
the number of consecutive data blocks.

19. The method of claim 16, wherein the location information comprises:
an address of a first data block of the consecutive data blocks; and
an address of a last data block of consecutive data blocks.

20. The method of claim 16, wherein the entry information comprises at least one of:
information indicating whether a defect exists in the consecutive data blocks;
information identifying a disc area to which the consecutive data blocks belong; and
information identifying a recording layer to which the consecutive data blocks belong if the write-once disc has at least two recording layers.

21. The method of claim 15, further comprising:
reading a final record map recorded on the write-once disc after the write-once disc is loaded in a data recording and/or reproducing apparatus;
wherein in the producing of the record map, an updated record map is produced by adding information to the final record map, the information indicating locations of data blocks in which the new data has been recorded.

22. The method of claim 15, wherein the record map is recorded in a temporary defect management area.

23. The method of claim 15, wherein the temporary defect management area comprises:
a temporary disc defect list to identify defective locations of the write-once disc and/or recently replaced areas of the write-once disc; and
a temporary disc defect structure to manage the temporary disc defect list.

24. The method of claim 23, wherein the temporary disc defect structure comprises at least one of:
a temporary disc defect structure identifier to indicate that an area of the write-once disc is used as a temporary disc defect structure;
an update counter to indicate a number of times the temporary disc defect list has been updated
information indicating where a final temporary disc defect list has been recorded; and
information indicating a size of a spare area used to replace a defective area of the write-once disc.

25. The method of claim 24, wherein the temporary disc defect structure comprises the record map.

26. The method of claim 15, wherein the record map further comprises:
a record map identifier to identify a disc area as containing a record map; and
a record map update counter to indicate a number of times that the record map has been updated with new data.

27. The method of claim 16, wherein each of the record map entries is composed of 8 bytes.

28. The method of claim 27, wherein of the 8 bytes, one byte is used for entry information, four bytes are used for a start address, and three bytes are used to indicate a number of consecutive data blocks.

29. The method of claim 20, wherein the defects may be caused by a loss of power while data is being written to the write-once disc.

30. A data recording and/or reproducing apparatus comprising:
a writer/reader to write data on a write-once disc or read written data from the write-once disc; and
a controller to:
control the writer/reader to write new data in the write-once disc in data block units,
produce a record map which identifies locations of occupied or unoccupied consecutive data blocks, and
control the writer/reader to record the record map in a predetermined area on the write-once disc.

31. The data recording and/or reproducing apparatus of claim 30, wherein:
the record map comprises a plurality of record map entries; and
each of the record map entries comprises:
location information identifying the locations of the occupied or unoccupied consecutive data blocks; and
entry information indicating whether the data has been recorded in the consecutive data blocks.

32. The data recording and/or reproducing apparatus of claim 31, wherein the location information comprises:
an address of a first data block of the consecutive data blocks; and
the number of consecutive data blocks.

33. The data recording and/or reproducing apparatus of claim 31, wherein the location information comprises:
an address of a last data block of the consecutive data blocks; and
the number of consecutive data blocks.

34. The data recording and/or reproducing apparatus of claim 31, wherein the location information comprises:
an address of a first data block of the consecutive data blocks; and
an address of a last data block of consecutive data blocks.

35. The data recording and/or reproducing apparatus of claim 31, wherein the entry information comprises at least one of:
information indicating whether a defect exists in the consecutive data blocks;
information identifying a disc area to which the consecutive data blocks belong; and
information identifying a recording layer to which the consecutive data blocks belong if the write-once disc has at least two recording layers.

36. The data recording and/or reproducing apparatus of claim 30, further comprising a memory for storing data,
wherein the controller:
controls the writer/reader to read a final record map recorded on the write-once disc after the write-once disc is loaded,
stores the final record map in the memory, and
produces an updated record map by adding information about locations of data blocks in which the new data has been recorded to the final record map.

37. The data recording and/or reproducing apparatus of claim 31, in which the controller controls the writer/reader to record the record map in a temporary defect management area allocated on the write-once disc.

38. The data recording and/or reproducing apparatus of claim 37, in which the record map is recorded when an amount of new data recorded to the disc reaches a predetermined size.

39. The data recording and/or reproducing apparatus of claim 38, in which the record map is recorded when the data recording and/or reproducing apparatus receives a command to stop recording the data.
